(19) United States
(12) Patent Application Publication
(10) Pub. No.: US 2003/0023577 A1
(43) Pub. Date: Jan. 30, 2003

(54) Method and apparatus for handling the registration of multiple and diverse communication protocols for use in an object request broker (ORB)

(75) Inventors: Ioana Sundius, San Francisco, CA (US); George Mark Scott, Sunnyvale, CA (US)

Correspondence Address: DARBY & DARBY P.C., 805 Third Avenue, New York, NY, 10022, US

(73) Assignee: BORLAND SOFTWARE CORPORATION

(21) Appl. No.: 10/017,476

(22) Filed: Dec. 14, 2001

Related U.S. Application Data
(60) Provisional application No. 60/255,568, filed on Dec. 14, 2000.

(51) Int. Cl. G06F 7/00

(52) U.S. Cl. 707/1

(57) ABSTRACT

An Object Request Broker (ORB) working in the Common Object Request Broker Architecture (CORBA) is structured to handle the registration of multiple and diverse communications protocols. The protocol engine of the ORB has it architecture modified so that it can accept a plug-in component which has a protocol connector and a protocol adapter portion for communication between client and server applications, respectively. The plug-in converts from the client/server applications to the General Inter-ORB Protocol used by the ORB. The plug-in will be fully operational if it has an interface to the rest of the ORB as required by the invention, including a protocol connection interface for the connector interface and Listener and Dispatcher interfaces for the server-adaptor interface.

This patent applications is based on Provisional Patent Application Serial No. 60/255,568 filed on Dec. 14, 2000, which is hereby incorporated by reference. Applicants claims the benefit of the filing date of the aforesaid Provisional Application under 35 U.S.C. §119(e)(1).

### BACKGROUND OF THE INVENTION

The present invention relates to data communications and, more particularly, to techniques for brokering object requests in a plurality of communications protocols.

The Common Object Request Broker Architecture (CORBA) is a standard promulgated by the Object Management Group. See www.omg.org. This standard relates to communications between distributed objects. CORBA provides a way to execute programs written in any language, no matter where they reside in the network or what platform they run on. It enables complex systems to be built across an entire enterprise. For example, three-tier client/server applications can be constructed using CORBA-compliant object request brokers (ORBs). CORBA is suited for widely distributed networks, where an event occurring in one location requires services to be performed in another. The communications protocol defined by CORBA is the General Inter-ORB Protocol (GIOP).

In CORBA, the client makes a request to a common interface, i.e. the ORB. The ORB directs the request to the appropriate server that contains the object and redirects the results back to the client. The required object might also be located on the same machine as the client.

Technically, CORBA is the communications component of the Object Management Architecture (OMA). However, CORBA is the term that is used to described the OMG environment rather than OMA. CORBA is also often described as an “object bus,” because it is a communication interface through which objects are located and accessed.

CORBA objects are defined by an interface definition language (IDL) that describes the services the object performs and the way data is passed to it. The IDL definitions are stored in an Interface Repository that can be queried by a client application to determine what functions (objects) are available on the object bus.

The first version of CORBA addressed source code portability across different platforms and implementations, for example IBM's SOM/DSOM, Sun Microsystem's DOE and Hewlett Packard's DOMF were designed to this specification. In late 1994, CORBA 2 was introduced to support interoperability between ORBs, so that an ORB from one vendor can communicate directly with an ORB from another. Borland has a CORBA compliant family of products called VisiBroker.

In this context, an ORB from any CORBA compliant vendor can be trusted to support GIOP and IIOP (Internet Inter-ORB Protocol, which is a mapping of the Internet protocol, TCP/IP). While this ensures inter-operability between orbs, it constraints the communication to only TCP/IP. CORBA does not prevent vendors from supporting additional protocols—in fact, it encourages it by providing place holders in the marshaled version of the message. Some ORB vendors have indeed implemented support for protocols such as DCE, HTTP, etc. The problem is that such additional protocols are hard-wired into a vendor's product offering, and an application writer can not register additional protocols, as dictated by the application. Such supported protocols are typically standard protocols, specific to particular fields, and vendors who sell such products limit themselves to a narrow market.

With the desirable protocols, not only may there be a need for a different data format for the messages, but the structure of the handshake itself may need to be utterly different across communication protocols. It is nearly impossible for a vendor to implement each such possibility for a protocol. Hence, there is a need for a system that allows ease of integration (possibly by a third-party vendor) of diverse protocols.

Most of the current ORB vendors are firmly relying on the client-server paradigm, along with a few variations on the same theme. Thus, a connection-oriented protocol is assumed (i.e. a client-server application, built on top of the TCP/IP Internet communication protocol). Further, all of the currently available protocols are hard-wired in the structure of the ORB, and it is a major undertaking to supporting any additional protocol. Such architectures are, by definition, highly proprietary, inflexible and monolithic.

Despite the difficulties with the client/server architecture (or peer-to-peer) in dealing with a plurality of protocols, the future seems even more daunting. Distributed systems are evolving past the client-server architecture, into various types of broadcast and mobile technologies that are definitely connectionless. The community will need to implement new standard protocols, such as the Multicast Inter-ORB Protocol (MIOP), currently being developed, or Wireless IOP which was recently proposed. Messaging technology needs to implement asynchronous protocols, routing and queuing. Also, the “Embedded Systems” industry is looking to use diminutive (small size) protocols to implement hand-held devices, protocols that in many cases are the essential proprietary technologies of a particular vendor. The ability to use such a proprietary protocol in a commercial ORB will play a major role if CORBA technology is to become ubiquitous in those markets. However, such technology is not currently available on the market.

### SUMMARY OF THE INVENTION

The present invention is directed to a device and method for allowing application writers to register additional, non-standard protocols with a CORBA compliant orb, thereby customizing the product to their particular application area, while avoiding the expose their proprietary protocol. The device and method can be applied to any CORBA 2 compliant ORB, and communication using a proprietary protocol seamlessly operates, provided all applications using the protocol also use a version of a CORBA-compliant ORB that was instrumented according to this invention. The invention provides an object request broker (ORB) which allows a user to plug in a proprietary or other user defined protocol and have it work. This is achieved by modifying the ORB protocol engine architecture such that an appropriate interface exists which can accommodate a plug-in protocol connector/adaptor combination so that the ORB can handle communications in the plug-in protocol when dealing with the client application, but work in GIOP when transmitting messages over the transport layer.

In an illustrative embodiment of the invention, the protocol stack of the ORB has the standard configuration of a transport layer, e.g., TCP/IP, a protocol layer and a service layer. The architecture of the protocol layer has a portion that uses GIOP in a standard fashion. However, the portion which connects to the client application is configured to work with a plug-in protocol connector/adaptor that translates from the protocol desired by the user to GIOP.

The protocol connector is in effect when the application is operating as a client. It connects to the remote server and issues requests. The protocol adapter makes the translation when the application is operating as a server and it accepts requests from clients and then initiates all other actions. The connector (client side) requires at least a protocol connection interface. The adapter (server side) requires at least a listener and a dispatcher interface. A listener interface allows a server to wait for an incoming request from some client. A dispatcher handles that request, by delegating the servicing of the request to the appropriate component of the server.

### BRIEF DESCRIPTION OF THE DRAWINGS

The foregoing and other features of the present invention will be more readily apparent from the following detailed description and drawings of an illustrative embodiment of the invention in which:

FIG. 1 is an illustrative embodiment of the architecture of a prior ORB protocol engine;

FIG. 2 is an illustrative embodiment of the architecture for an ORB protocol engine according to the present invention which is modified to accept a plug-in protocol adaptor/connector.;

FIG. 3 is a block diagram of the client side modules for implementing the present invention;

FIG. 4 is a block diagram of the server side modules for implementing the present invention;

FIG. 5 is a Unified Modeling Language (UML) diagram on the client side for implementing the present invention; and

FIG. 6 is a Unified Modeling Language (UML) diagram on the server side for implementing the present invention.

### DESCRIPTION OF ILLUSTRATIVE EXEMPLARY EMBODIMENTS

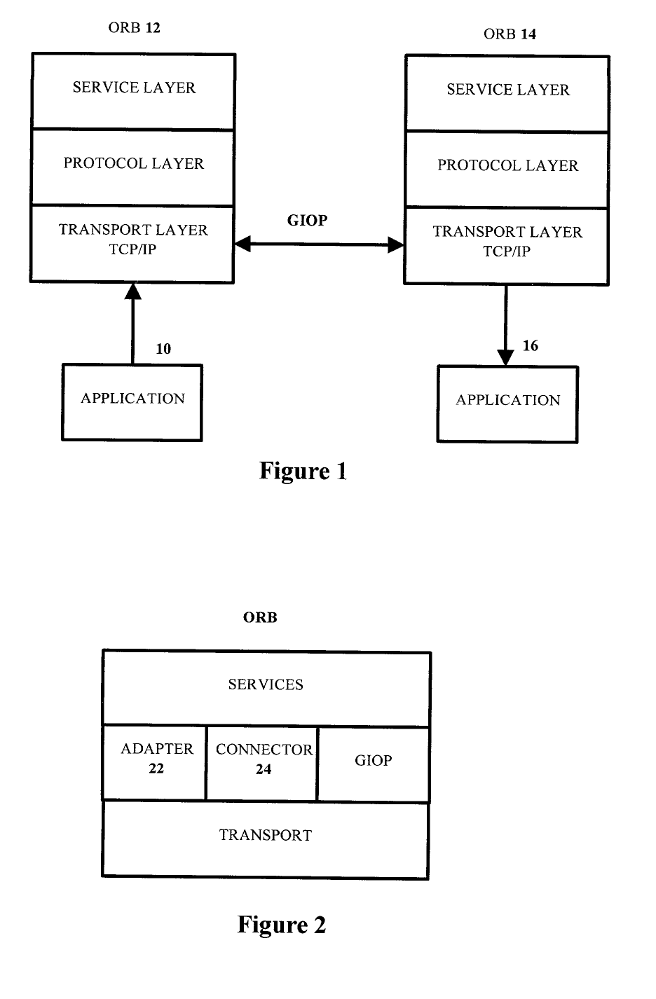

As shown in FIG. 1, a Protocol Engine is the heart of the ORB responsible for the flow of messages to and from clients and servers. In particular, a client application 10 sends a request to ORB 12 for information from server application 16. For example, a depositor may request the status of his bank account from the bank's server. ORB 12 sends the message to ORB 14 using GIOP. This is converted into a request to server 16. The reply takes the reverse direction. Naturally, in some situations the client can operate as a server and vise versa, for instance, in a multi-tier model, when an applications services incoming requests by invoking operations on a lower layer.

The protocol engine of each GIOP (FIG. 1) is made up of several components:

Transport—The lowest layer in the protocol stack responsible for sending and receiving streams of bytes to remote processes. For example, this may be TCP/IP data packets.

Protocol—The layer responsible for converting streams of bytes into blocks of data known as messages. This layer is also responsible for converting data in those messages to their appropriate programming language constructs through a process known as marshaling.

Quality of Service (QoS)—Responsible for providing various qualities of service throughout the protocol engine. This includes thread and connection management on both the client and the server.

In the prior art, the portions of the protocol layer that handle server operations and the portion that handle client operations are integrated into a monolithic structure.

According to the present invention, and as shown in FIG. 2, the protocol layer architecture is modified so that the portion of the protocol engine that directly communicates with the server or client application is isolated. Instead, a protocol adapter 22 is provided which communicates with the server side application, while the client-side application deals with a protocol connector 24. The goal of this arrangement of the protocol engine is to provide as much independence as possible between the various components that make up the protocol engine. Thus, the various components, such as a protocol implementation and a transport implementation, can be mixed and matched to produce new combinations of protocol stacks.

It is possible, and it is a part of the present invention to have the protocol engine allow user-code to be executed at certain points in the protocol engine processing. In particular, the protocol adapter 22 and the protocol connector 24 can be user defined code that accepts inputs in any of a plurality of diverse codes and translates them into GIOP for operation with the rest of the ORB. Since the protocol layer is no longer monolithic, these can be designed and plugged-in as desired without redoing the entire protocol stack. All that is necessary is that the plug-in adaptor and connector conform to interface requirements as set forth below. These interface requirements on the server side adapter include a listener and a dispatcher, while the client side connector minimally requires a protocol connector.

By way of background, all aspects of even conventional protocol engines are controlled via properties. The properties determine how various components are hooked together and the specific properties of each component. All properties follow the following design pattern:

The core data structures as defined in the CORBA Inter-ORB Protocol (IOP) module define the standard set of data structures which define interoperability of ORBs. ORB products have traditionally used these data structures internally in the ORB in their marshalled form, resulting in a large amount of marshalling/unmarshalling during the processing of Interoperable Object References (IORs) and their contents. This process is very wasteful and hinders performance, especially during object bind operations or services which must process IORs, like the creation of an implementation repository such as the Object Activation Daemon (OAD).

Furthermore, interceptor application program interfaces (APIs) used in the ORBs exposed these raw interfaces while providing very little help to the user in accessing those APIs. According to the invention, there is provided a more sophisticated API abstraction for manipulating these data structures within the ORB as well as for users. The two main concepts being abstracted are IORs and service contexts, the two data structures most commonly manipulated by other ORB services. For example to implement the latest Object Transaction Service (OTS) specification it is necessary for the OTS to add components to an IOR if the Portable Object Adaptor (POA) policies indicate that the POA is supporting a particular transactional model. In addition the OTS must be able to insert service contexts as requests, and replies are sent so that transaction contexts are correctly propagated from client to server.

The core set of APIs is defined as an additional set of interfaces and valuetypes in the IOP module as follows:

module IOP {

typedef unsigned long ProfileId;
struct TaggedProfile {

ProfileId tag;
sequence<octet>profile_data;

};
abstract valuetype ProfileValue {

readonly attribute ProfileId tag;
TaggedProfile to TaggedProfile();

};
valuetype UnknownProfile : ValueBase, ProfileValue {

CORBA::OctetSequence getProfileData();

};
interface ProfileValueFactory {

ProfileValue create(in TaggedProfile profile);

};
struct IOR {

string type_id;
sequence<TaggedProfile>profiles;

};
valuetype IORValue {

public string type_id;
public sequence<ProfileValue>profiles;
IOR toIOR();
Object toObject();
init();
init(in Object obj);
init(in IOR ior);

};
typedef unsigned long ComponentId;
struct TaggedComponent {

ComponentIdtag;
sequence<octet>component_data;

};
abstract valuetype ComponentValue {

readonly attribute ComponentId tag;
TaggedComponent to TaggedComponent();

};
valuetype UnknownComponent : ValueBase, ComponentValue {

CORBA::OctetSequence getComponentData();

};
interface ComponentValueFactory {

ComponentValue create(in TaggedComponent component);

};
typedef unsigned long ServiceID;
struct ServiceContext {

ServiceID context_id;
CORBA::OctetSequencecontext_data;

};
abstract valuetype Service {

readonly attribute ServiceID context_id;
ServiceContext toServiceContext();

};
typedef sequence<Service>ServiceList;
valuetype UnknownService {

CORBA::OctetSequence get ContextData();

};
interface ServiceFactory {

Service create(in ServiceContext ctx);

};
typedef sequence<ServiceContext>ServiceContextList;
interface EntityRegistry {

void registerProfilefactory(in ProfileId tag,

in ProfileValueFactory factory);

void registerComponentFactory(in ComponentId tag,

in ComponentValueFactory factory);

void registerServiceFactory(in ServiceID tag,

in ServiceFactory factory);

ProfileValueFactory getProfileValueFactory(in ProfileId tag);
ComponentValueFactory getComponentFactory(in ComponentId

tag);

ServiceFactory getServiceFactory(in ServiceID tag);
};

};

IORs are manipulation using the IORValue, ProfileValue, and ComponentValue valuetypes. These valuetypes simply provide an abstraction to the existing data structures defined in IDL, and provide methods to map from the abstraction to the on-the-wire format. IORValues may be created directly by calling one of the valuetype's initializers or may be created automatically by the ORB before being passed to interceptor calls. Typically the ORB will create an IORvalue immediately after receiving the IOR on the wire. The ORB may then use the IORvalue for protocol/stub selection.

For an IORValue to be constructed, it will need to construct the appropriate ProfileValue components, which in turn may need to construct ComponentValues. To support the creation of ProfileValues and ComponentValues, a factory (software that creates objects as needed) must be installed for each profile or component tag supported. The factory may be directly implemented by the ORB or the end-user, but must be installed in the EntityRegistry. Note, both the ProfileValueFactory and ComponentValueFactory can only create values from their marshalled state. To construct a component or profile from scratch, the initializer of the correct valuetype should be called directly.

Service context are manipulated using the Service valuetype. Just as with IOR manipulation, factories must be created and installed so that the ORB can create Service valuetypes from their marshalled state.

The entity registry is responsible for registering and returning ProfileValueFactories, ComponentValueFactories, and ServiceFactories. Only one factory may be installed for each “tag” associated with a profile, component, or service context. The entity registry may be obtained by invoking ORB.resolve_initial_references with the string “IOPEntityRegistry” as an argument. Note, that this value is only available when the ORB is in administrative mode (i.e., during ORB initialization).

The APIs defined above are truly generic in that they only encompass those data structures defined in the CORBA IOP module. Additional APIs are required for specialization within the GIOP set of on-the-wire protocols. In particular, all GIOP protocols must support the notion of an opaque object key and the GIOP protocol version to be used for client-server communication must be specified in the IOR. These concepts are captured in the GIOP::ProfileBodyValue and GIOP::ObjectKey valuetypes which are defined in IDL below.

The ProfileBodyValue extends the ProfileValue and adds the information model required for all GIOP based protocols to the GIOP version and object key. The ObjectKey class provides an opaque view of the ObjectKey. In addition, subclasses of the ObjectKey valuetype provide program specific views for each of our supported object key formats.

A specialized EntityRegistry is also defined which allows one to create an ObjectKey valuetype from an octet sequence. The EntityRegistry returned by the ORB, as defined above, can always be narrowed to GIOP::EntityRegistry.

module GIOP {

struct Version {

octet major;
octet minor;

};
abstract valuetype ObjectKey {

CORBA::OctetSequence to OctetSequence();

};
valuetype UnknownObjectKey:ValueBase, ObjectKey {
};
// define our other object keys here
// PersistentId, etc.
valuetype ProfileBodyValue: ValueBase, ::IOP::ProfileValue {

public GIOP::Version version;
public ObjectKey object_key;

};
interface EntityRegistry : ::IOP::EntityRegistry {

ObjectKey get ObjectKey(in CORBA::OctetSequence
object_key);

};

};

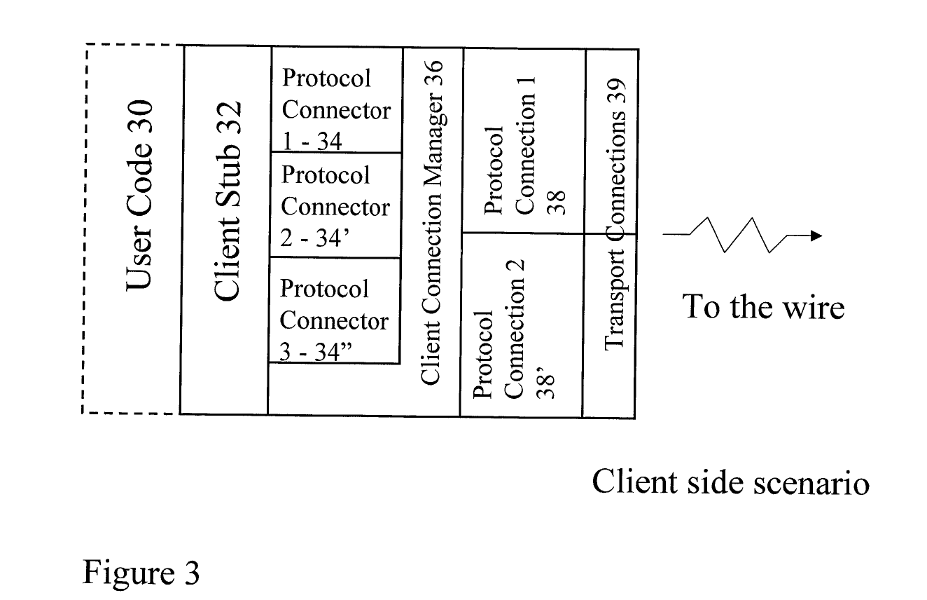

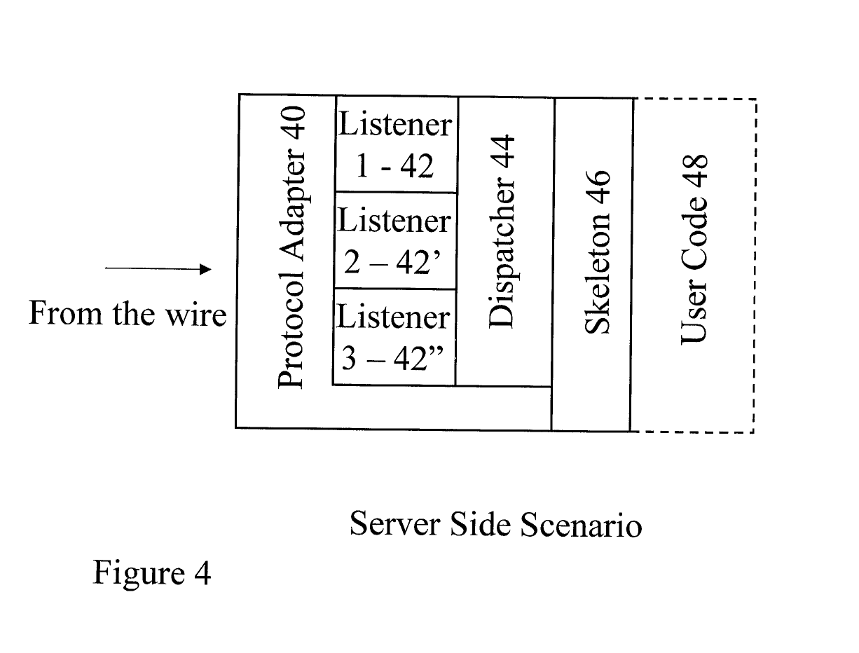

The client protocol engine defines the interfaces that are necessary to allow the user defined protocols to operate with the ORB. It is composed of the following parts as shown in FIGS. 3 and 4:

ProtocolConnector—For each stub 32, the connector uses a (potentially shared) protocol connection 34 to communicate with target object, where the stub is the code generated from the user code in an interface definition language (IDL).

ProtocolConnection—An abstracted protocol connection 38 which wraps the transport connection 39.

TransportConnection—An abstract notion of connection which wraps the OS transport layer

ClientConnectionManager—A module 36 that manages client connections. All outgoing connections are created via the connection manager 36 and never directly via the transport connection factories.

A protocol connector 34 is the entry point into the client protocol stack, which a stub routine 32 uses to connect to the remote server and issue requests. The process of assigning a protocol connector 34 to a stub is known as binding. Once a binding has been established between a stub and a protocol connector, that protocol connector will continue to be used until one of the following occurs:

The connection to the server is lost, or

The connector is instructed by the server to forward the client to a new IOR.

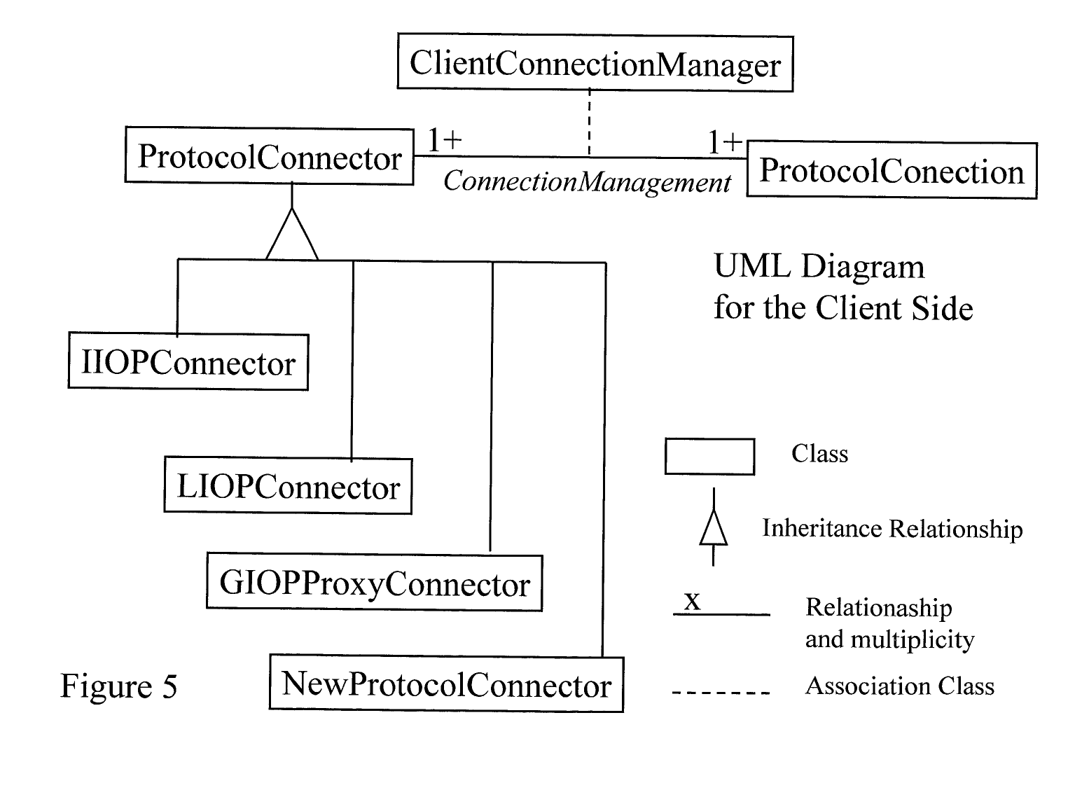

The process of changing a protocol connector is known as rebinding. Rebinding may only occur if the quality of service policies in place for a stub allow it. Protocol connectors 34 are created on a per-stub (or per-stub delegate) basis. Protocol connectors may vary depending on needs and may include one or more of the following as shown in FIG. 5:

IIOP Protocol Connector

LIOP Protocol Connector (C++ only (possibly Java if time permits))

HIOP Protocol Connector (Java only)

GIOP Proxy Protocol Connector

Local Stub Protocol Connector

IIOP/SSL Protocol Connector

HIOP/SSL Protocol Connector (Java only)

LIOP/SSL Protocol Connector

With this background in mind, the invention can now be considered. The protocol engine specifies an abstraction notion of a message. A message corresponds to the protocol commands sent to issue requests and receive replies on a target object (e.g. GIOP Request and Reply messages). Protocol implementations may send other message types but they are not of concern to the protocol engine. The interfaces below are all rendered in pseudo-code inspired from the natural language for interface definitions, IDL. This is not a constraint of the invention, rather a choice of language for presenting a device that can be implemented in any other language. The actual language and wording of the interface definition is not part of the invention; but the concepts behind the interface are part of the invention. The interface in pseudo-code for a message according to the invention is as follows:

module ProtocolEngine {

abstract interface Message {

interceptor::OutputStream messageWriter();
interceptor::InputStream messageReader();

};
abstract interface RequestMessage : Message {
};
abstract interface ReplyMessage : Message {

boolean isUserException();
boolean isSystemException();
boolean isForwarded();

};

};

The Message interface is an abstract notion of the a message. It provides methods to get access to marshal streams for reading and writing to the message. A message which was received will only allow the creation of a messageReader, while a message which was created by the protocol connector will only allow access to the messagewriter. An attempt to access the other type of stream will result in a BAD_INV_ORDER exception being raised, denoting an incorrect handshake order.

The RequestMessage extends the Message interface, but adds no additional operations.

The ReplyMessage extends the Message interface and adds some additional operations to process replies. The methods are provided to allow the stub to distinguish certain error cases so that it may properly process rebinds and other error conditions.

The isSystemException( ) method returns true if the reply contains a system exception. The exception may be unmarshalled by accessing the messageReader( ). The isUserException( ) method returns true if the reply contains a user exception. The exception may be unmarshalled by accessing the messageReader( ). The isForwarded( ) method returns true if the reply resulted in a forward. The IOR may be read by unmarshalling.

Another interface according to the invention is the protocol connector Application Program Interface (API). It is defined by the following IDL:

module ProtocolEngine {

abstract interface ProtocolConnector {

| | |
|---|---|
| RequestMessage request | (in string operation, |
| | in boolean responseExpected, |
| | in IOP::ServiceValueList services, |
| | in boolean byteOrder); |
| ReplyMessage invoke | (in RequestMessage request, |
| | in long long timeout); |

void reconnect(in long long timeout);

};

};

The stub invokes the request method to construct a RequestMessage. The request method is invoked after invoking all client pre-marshal interceptors. The stub typically returns the request message or the marshal buffer for the request message to the stub for marshalling. The stream given to the stub must cache a reference to the protocol connector as well as the interceptor chain in case another thread causes a rebind before the request message may be issued.

The invoke method is called after the stub (Dynamic Invocations Interface or DII) has marshalled the arguments if any, and after all post-marshal interceptors have been invoked. The invoke method returns a ReplyMessage which may be examined to determine how to properly handle the reply. A user or system exception reply will result in the exception being raised. A location forward will result in an immediate rebind with the new IOR. The invoke method itself may throw a system exception which will be handled by the stub as follows:

COMM_FAILURE—must be presented to the user, but a rebind will occur on the next use.

A COMM_FAILURE indicates the request was sent, but a connection failure occurred while waiting for the reply. The request may have already been dispatched to the server so the user must be notified.

TRANSIENT—the connection went down during the send. This is a candidate for immediate rebind if policies allow.

All other exceptions are presented directly to the user, no rebind occurs.

The reconnect( ) method is used to force the protocol connector to attempt a reconnect. This method is invoked if the QoS policies allow reconnect to the same server without a rebind occurring. Bind interceptors are not called for this case, as it is considered to be part of connection management and transparent to user/interceptor alike. Connection is established by bind/reconnect and is removed by reconnect/quit.

One of the most important interfaces on the client side is the protocol connection. The protocol connection is a protocol abstraction on top of the transport connection. It adds additional semantics that are required to implement connection management. In particular, it is aware of whether or not the connection is “in use” meaning that there are requests pending on that connection. This indicates to the connection manager that the connection cannot be closed safely and transparently. The ProtocolConnection essentially holds the state of the association between a stub and a ProtocolConnector. The protocol connection interface is:

module ProtocolEngine {

abstract interface ProtocolConnection {

// returns true if the protocol connection is inUse
boolean inUse();
// returns the time this connection was last used
long long lastUsed();
// attempts to close the connection, returns true if connection
// was close succesfully or false if unable to close connection
// because it was in use.
boolean close();

};

};

The inUse( ) method returns true if the connection is in use, and false otherwise. The connection is in use is if the connection has sent requests for which it has not received replies, or received requests for which it has not issued a reply. The lastUsed( ) method indicates the time the connection was last used to send or receive a message and can be used by connection management algorithms to implement LRU style connection management policies. The close( ) method is used to safely close a connection. It returns true if the connection was successfully closed and false otherwise. It is not safe to close a connection while it is in use.

A further client interface is the connection manager, which defines a service that manages client (outgoing) connections for the ORB. The ORB may initially be supplied with a default connection manager which supports simple connection pooling. In addition, a per-thread connection manager may be implemented to support scalability testing. Also, the GateKeeper provides its own connection manager to increase GateKeeper throughput. This interface is defined as follows:

module ProtocolEngine {

abstract interface ClientConnectionManager {

ProtocolConnection connect(ProtocolConnectorBid bid);
void release(ProtocolConnection connection);

};

};

All connections are created via calling the connect( ) method on the connection manager. The connection manager returns a protocol connection corresponding to the bid. It may do this by invoking the bid or by returning a cached connection corresponding to the bid. To correctly support this behavior it is essential that all bids implement correct hash and equals semantics as required.

The release method is called by a ProtocolConnection when it is no longer in active use, typically after all protocol connectors no longer reference it. The protocol manager may then cache the connection for future use or simply close the connection.

FIG. 3 shows an exemplary implementation of the client-side modules of the present invention. The User Code 30 is application code that a user writes, and which makes a call to a remote server. In CORBA, such a remote call was scripted in the language-independent Interface Definition Language (IDL), which acts as a contract between client and server, describing the type of interfaces to which the server can respond. Executable code, in the language of the user's choice (Java, C++), is then generated from the IDL, and bound to the user's application program. This generated code is called a “stub” on the client side and a “skeleton” on the server side.

This is the code that calls into the ORB vendor's libraries to further process the client message to the point where it can handle multiple protocols.

Clients and Servers need not support the same exact set of protocols. However, a CORBA compliant ORB will always need to support IIOP. For a client and a server to communicate, there needs to be at least one protocol that both understand for the connection to be established.

In FIG. 3, the client side supports three protocols, and therefore has ProtocolConnectors 34, 34′, 34″, one for each supported protocol. The operating system will impose some restrictions on the system resources a certain application can use. In this situation, there are only two connections 38 available. Establishing a connection means associating a ProtocolConnector 34 with one such ProtocolConnection 38 (an abstraction of the physical connection). In other words, to establish a connection, the system needs to find one Protocol that both client and server can understand, elect the associated ProtocolConnector for that protocol, and querry the system for a connection resource to be used. The ClientConnectionManager 36 controls this handshake, and manages available connections for the application. There is only one ClientConnectionManager per application, and it allocates connections to outgoing requests according to its own algorithms.

The TransportConnection 39 is a further refinment of the ProtocolConnection abstraction. More than one transport-level protocol may be supported (TCP/IP, ATM or local invocations, for instance), and on top of each such transport-level protocol, more than one high level protocol may be implemented. For instance, the standard IIOP protocol may be enhanced with a secure socket for a security service. At transport level, it is still TCP/IP, but the higher level IIOP has been enriched to support security, thus becoming IIOP/SSL. Therefore, there is no one-to-one relationship between the high level protocols and the transport on which they are implemented.

FIG. 5 shows the Unified Modeling Language (UML) diagram (static view) of the Client side. It is another way of looking at the above items. The association between the ProtocolConnector and the ProtocolConnection is managed by the ClientConnectionManager, and a given connection may service more than one request or protocol. The ProtocolConnection can be of a known type (IIOP, LIOP, etc) or a new one, specific to the application or domain.

The foregoing were the client or connector interfaces definitions. For a complete system, the server side interfaces must also be defined. The Server side interface consists of a Protocol Adapter, a Listener, and a Dispatcher. The Protocol Adapter is the entry point into the server-side stack It establishes the receiver's connection to the communication medium, and is used to establish a connection, check on the connection's usage statistics and for closing that connection. This interface is defined as follows:

interface ProtocolAdapter {

boolean inUse();
unsigned long long lastUsed();
boolean close();
getConnection();

};

Protocol adapter Listeners are responsible for accepting new connections from clients and then initiating all other actions which will result in a client being able to issue requests to the server. There is generally one Listener per protocol adapter, but in some cases such as IIOP/SSL it is necessary to support multiple listeners for a single protocol adapter. In such configurations there is normally a master listener and one or more slave listeners. The master listener is responsible for creating and managing the IOP profile which describes the listener, while the slave listeners may only add additional components to that profile.

The Listener interface is defined as follows:

abstract interface Listener {

Connection accept(in long long timeout);
IOP::ProfileValue listenEndpoint();
void destroy();

};

The accept method accepts a new connection from a client. The timeout parameter specifies the time to wait for a new connection before returning. A timeout value of 0 will cause the call to block until anew connection is accepted. The listenEndpoint method returns an IOP::ProfileValue representing the template for the listener. The template is complete except for information specific to the target object such as a GIOP object key. This information will be filled in by the object adapter when it creates a reference. The destroy method destroys the listener and any OS resources related to the listener. For socket based listeners this is equivalent to closing the listen socket.

The Dispatcher handles the thread model for handling incoming information. This part of the interface is defined as:

interface Dispatcher {

void do_work( in ProtocolAdapter pa);
void shutdown();
void dispatch();

};

FIG. 4 shows the interfaces as they would be used on the server side in an actual application. As the incoming message is received on the server side, the ProtocolAdapter 40 “accepts” the connection when it recognizes that the server has at least one Listener 42 that understands any of the protocols that the client supports. The incoming message encodes all the protocols that the client supports, and as a result of the bind process, a protocol that both client and server can understand is selected. As a result of the connection being established, the designated listener for the established protocol will be waiting for further incoming calls on the connection, until the connection expires. For each request the listener 42 receives, the dispatcher 44 allocates a thread to service the request, according to its own internal algorithm. Such execution thread then turns to the skeleton 46 (generated code on the server side from the original IDL), which in turn delegates to the user code 48 for execution of the request. Replies follow the same route and responses go back to the client using the same connection and the same protocol as the request.

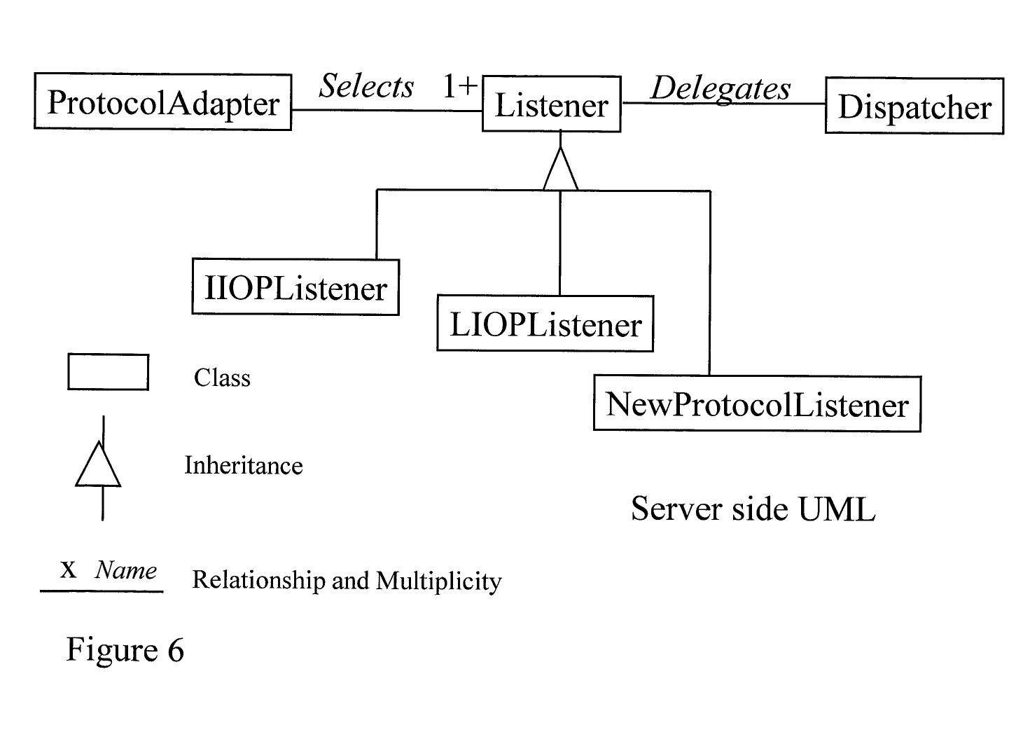

FIG. 6 shows the UML diagram for the server side of the connection. In this example, the server supports IIOP, LIOP and some new, application-specific protocol. As opposed to the client in a previous example (FIG. 5), the server cannot handle GIOPProxy connections, because it has no listeners that understand that protocol. If the communications were limited so they were required to go through a firewall that only supports the GIOPProxy protocol, the client and server could not communicate in these examples.

Thus, the client (connector) portion of the interface defines a protocol message, protocol connector API, protocol connection and client connection manager. While some or all of these are useful in allowing a complete user defined protocol, the protocol connector is required. On the server (adaptor) side the interface defines a protocol adaptor with a protocol adaptor Listener and protocol adaptor Dispatcher. The Listener and Dispatcher are necessary.

The plug in components may also include a scheduler. Thus, by substituting one plug-in module for another, not only can different protocols be handled, but different schedules can be invoked.

The method for plugging in a new connection-oriented protocol therefore consists of:

Client side (either or both of:)

1. Implementing a ProtocolConnector specific to the new protocol supported. The connector needs to support marshalling/demarshalling operations for read/write messages handled by the protocol.

2. Implementing a new connection management algorithm, essentially controlling the allocation of the limited connections made available by the operating system.

Server side (either or both:)

1. A. Implementing a new Protocol Adapter, which can recognize the new protocol.

B. Implementing a new Listener scheme. If replacing the IIOP protocol completely, implementing a new master Listener for the protocol. If supporting a new protocol in addition to IIOP, then a slave Listener needs to be implemented.

2. Implementing a new Dispatcher, if required.

There are therefore five areas where innovation is supported with this framework

While the invention has been particularly shown and described with reference to a preferred embodiment thereof, it will be understood by those skilled in the art that various changes in form and details may be made therein without departing from the spirit and scope of the invention.

We claim:

1. A method for handing Object Request Broker (ORB) communications for a system designed in the Common Object Request Broker Architecture (CORBA), comprising the steps of:
creating a plug-in component for a desired client/server application program protocol selected from multiple and diverse communications protocols, said component including a protocol adaptor/connector connecting the ORB and client server applications;
structuring a base communications protocol for the ORB to accept said plug-in components so as to translate the client/server application protocol to the General Inter-ORB Protocol (GIOP) of CORBA; and
combining the plug-in component and the base communications protocol so that the combination ORB handles communications from the client/server application in the desired application protocol.

2. The method for handling ORB communications as set forth in claim 1, further including the step of:
registering at least one other plug-in component for a desired communications protocol out of a plurality of protocols; and
substituting one of the plug-in components in the combination to cause the system to communicate in the protocol related to the substituted protocol.

3. The method for handling ORB communications as set forth in claim 2 wherein the plug-in component includes a scheduler and the schedules changes when the other plug-in is substituted.

4. The method for handling ORB communications as set forth in claim 1, wherein the protocol adaptor/connector defines a connector interface which includes a protocol connector.

5. The method for handling ORB communications as set forth in claim 1, wherein the protocol adaptor/connector defines an adapter interface which includes a Listener and a dispatcher.

6. Apparatus for handing Object Request Broker (ORB) communications for a system designed in the Common Object Request Broker Architecture (CORBA), comprising
a plug-in component for a desired protocol related to one of a multiple of diverse communications protocols; and
a base communications protocol component for the ORB, said base protocol being adapted to accept said plug-in component so as to translate the internal CORBA structure to a desired communications protocol.

7. An article of manufacture having computer readable program means embodied therein for causing Object Request Broker (ORB) communications for a system designed in the Common Object Request Broker Architecture (CORBA) to operate with a desired protocol related to one of a multiple diverse communications protocols, comprising
a plug-in component for a desired client/server application program protocol selected from multiple and diverse communications protocols, said component including a protocol adaptor/connector connecting the ORB and client server applications;
a base communications protocol for the ORB to accept said plug-in components so as to translate the client/server application protocol to the General Inter-ORB Protocol (GIOP) of CORBA; and
wherein the plug-in component and the base communications protocol are combined so that the combination ORB handles communications from the client/server application in the desired application protocol.

8. The article of manufacture as set forth in claim 7, further comprising:
at least one other plug-in component for a desired communications protocol out of a plurality of protocols, said other plug-in component being registered; and
means for substituting one of the other plug-in components in the combination to cause the system to communicate in the protocol related to the substituted protocol.

9. The article of manufacture as set forth in claim 8 wherein the plug-in component includes a scheduler and the schedules changes when the other plug-in is substituted.

10. The article of manufacture as set forth in claim 7, wherein the protocol adaptor/connector defines a connector interface which includes a protocol connector.

11. The article of manufacture as set forth in claim 7, wherein the protocol adaptor/connector defines an adapter interface which includes a Listener and a dispatcher.

12. A method for handing requests for service over a communications system designed with multiple protocol levels, comprising the steps of:
at a client processor:
providing at least one protocol connector;
using a client stub component to provide a plug-in protocol connector component for at least one desired client/server application program protocol selected from multiple and diverse communications protocols;
using a client connection manager component to establishing a connection between one of said protocol connector and said plug-in protocol connector, and at least one protocol connection component; and
connecting the protocol connection to a transport connection, said transport connection establishing communications with a server processor, and
at said server processor:
providing at least one protocol listener;
using a server skeleton component to provide a plug-in listener for at least said desired client/server application program protocol;
using a server dispatcher component to establishing a connection between one of said listener and and said plug-in listener, and a protocol adapter, said adapter establishing communications with said transport connection of said client.

13. The method for handing requests for service over a communications system as set forth in claim 12, further including the step of:
using said client stub to provide at least one other plug-in protocol component for a desired communications protocol out of a plurality of protocols; and
using said client connection manager to substitute the other plug-in protocol component for connection to said protocol connector.

14. The method for handing requests for service over a communications system as set forth in claim 13, wherein the plug-in component includes a scheduler and the schedules changes when the other plug-in is substituted.
